(19) United States
(12) Patent Application Publication
(10) Pub. No.: US 2022/0107915 A1
(43) Pub. Date: Apr. 7, 2022

(54) FILE OVERWRITE PROTECTION

(71) Applicant: Lenovo (Singapore) Pte. Ltd., Singapore (SG)

(72) Inventors: John Carl Mese, Cary, NC (US); Arnold S. Weksler, Raleigh, NC (US); Mark Patrick Delaney, Raleigh, NC (US); Nathan J. Peterson, Oxford, NC (US); Russell Speight VanBlon, Raleigh, NC (US)

(21) Appl. No.: 17/060,521

(22) Filed: Oct. 1, 2020

(51) Int. Cl. G06F 16/11; G06F 16/14; G06F 16/17

(52) U.S. Cl. CPC G06F 16/122; G06F 16/1734; G06F 16/148

(57) ABSTRACT

One embodiment provides a method, including: detecting, at an information handling device, at least one edit made to a file; receiving, subsequent to the detecting, a file save event for the file; determining, using a processor, that at least one edit exceeds a change threshold for the file; and performing, responsive to the determining, an overwrite protection action. Other aspects are described and claimed.

### BACKGROUND

Individuals frequently utilize their information handling devices (“devices”), for example laptop and/or personal computers, tablet devices, smart phones, hybrid devices, and the like, to perform a variety of different tasks. For instance, users may interact with a word processing application to create one or more documents. Upon completion, users may save their work which may thereafter be stored on the device or at another remote source.

### BRIEF SUMMARY

In summary, one aspect provides a method, comprising: detecting, at an information handling device, at least one edit made to a file; receiving, subsequent to the detecting, a file save event for the file; determining, using a processor, that at least one edit exceeds a change threshold for the file; and performing, responsive to the determining, an overwrite protection action.

Another aspect provides an information handling device, comprising: a processor; a memory device that stores instructions executable by the processor to: detect at least one edit made to a file; receive, subsequent to the detecting, a file save event for the file; determine that at least one edit exceeds a change threshold for the file; and perform, responsive to the determining, an overwrite protection action.

A further aspect provides a product, comprising: a storage device that stores code, the code being executable by a processor and comprising: code that detects at least one edit made to a file; code that receives, subsequent to the code that detects, a file save event for the file; code that determines that at least one edit exceeds a change threshold for the file; and code that performs, responsive to the determining, an overwrite protection action.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of dynamically preventing file overwrite.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Oftentimes when opening and editing a file, a user may inadvertently overwrite the original file. When this happens, valuable data may be lost and/or the original document may not be able to be recovered. As an example of the foregoing, a user working in and/or making edits to Document A may instinctively press the “save” button when they actually meant to “save as” in order to save a new document that comprises the edits to Document A.

Solutions exist to prevent the foregoing situation from occurring. For example, a user may always make, open, and work within a copy of the original document. Alternatively, a user could always mark files as “read-only” prior to working them. Such working methodologies, however, are not common. Another solution involves a user undoing the edits they made to the original document prior to saving (e.g., by pressing “control+z”, etc.). However, users often forget to perform this undo function. Cumulatively, all of the foregoing solutions require some type of additional manual user action that is burdensome and that can be easily overlooked.

Accordingly, a method is provided that enables a system to enact one or more overwrite protections when a change threshold of edits has been identified. In an embodiment, at least one edit made to a file may be detected. An embodiment may then receive, subsequent to the detection, a file save event for the file (i.e., a device may detect a user-initiated file save action). Then, an embodiment may determine whether the edit(s) exceed a change threshold for the file and, responsive to determining that it does, may perform some type of overwrite protection action (e.g., an embodiment may automatically prevent the edits from being saved, an embodiment may provide a confirmation query to the user, an embodiment may initiate another type of file save event, etc.). Such a method may ensure that a user does not inadvertently overwrite an original file.

The illustrated example embodiments will be best understood by reference to the figures. The following description is intended only by way of example, and simply illustrates certain example embodiments.

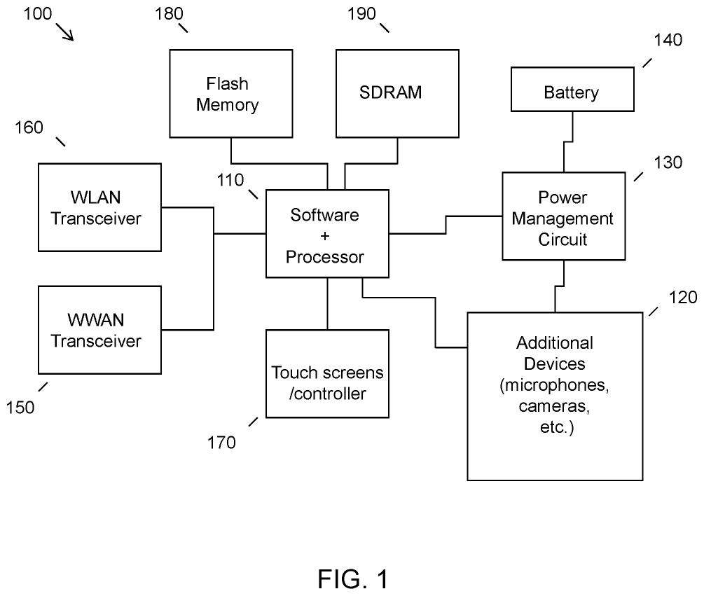

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

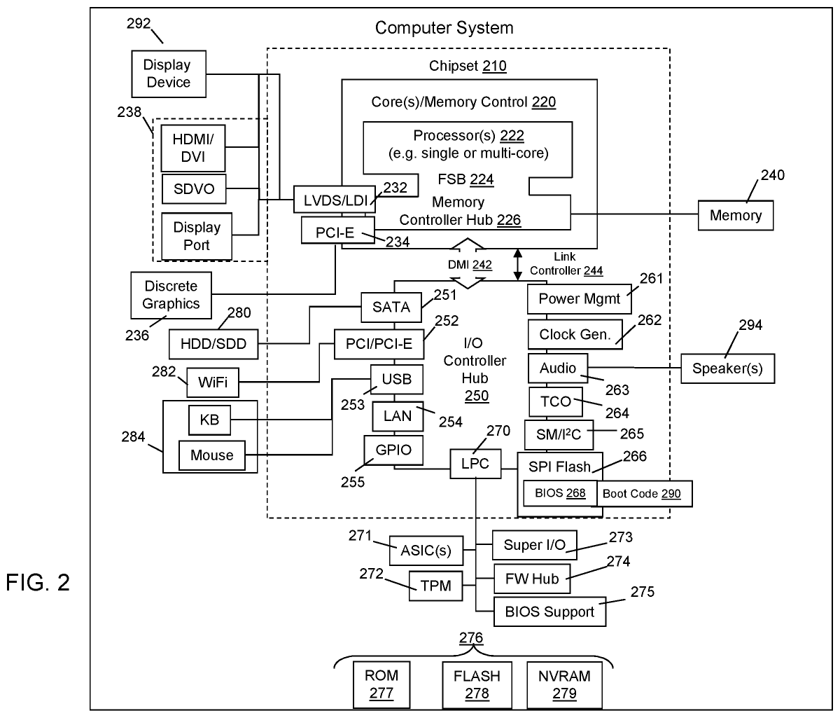

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices capable of receiving user edits and save inputs to a document. For example, the circuitry outlined in FIG. 1 may be implemented in a smart phone or tablet embodiment, whereas the circuitry outlined in FIG. 2 may be implemented in a laptop.

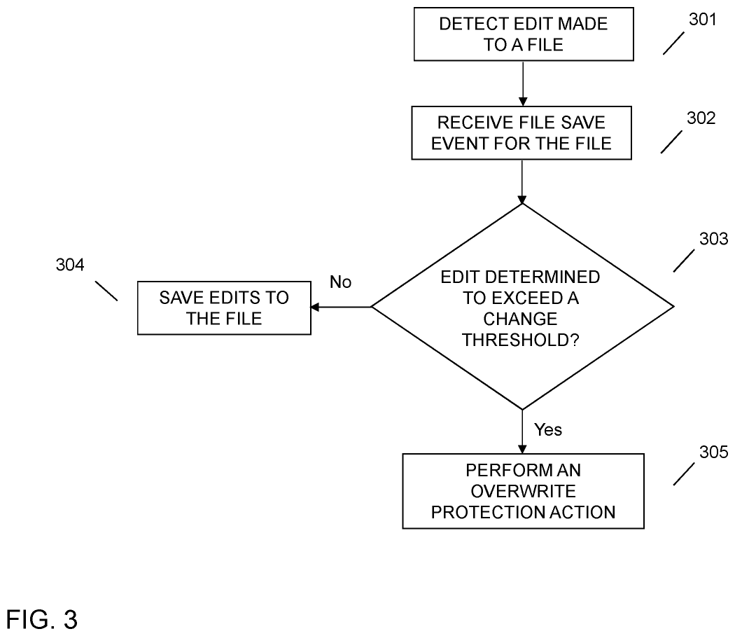

Referring now to FIG. 3, a method for automatically preventing a file from being overwritten is provided. At 301, an embodiment may detect at least one edit made to a file. In an embodiment, the file may be virtually any type of file that is capable of receiving user edits. For example, the file may be a text file, audio file, image file, video file, presentation file, executable file, and the like. In an embodiment, the at least one edit may be virtually any type of edit that can be made to the file by the user. For example, the edit may be a change to one or more words or images, an insertion or deletion of content, etc. An embodiment may facilitate detection of the edit(s) through conventional means (i.e., by identifying that the original source file has been changed by one or more user inputs).

At 302, an embodiment may receive a file save event for the file. In the context of this application, the file save event corresponds to a save action that directs the system to save the outstanding edits into the source file. The file save event may originate from a human user or, alternatively, may originate from another source. In case of the latter, certain systems or applications may be programmed to automatically save all edits to a file at predetermined intervals (e.g., after a predetermined time interval, after a predetermined period of inactivity, after a predetermined number of edits are received, etc.).

At 303, an embodiment may determine whether at least one edit exceeds a change threshold for the file. The change threshold may be based on one or more of the following parameters.

In an embodiment, the change threshold may be based upon a date and/or time associated with the file. More particularly, an embodiment may identify that a date and/or time associated with the current edits made to the file is not consistent with the date and/or time associated with the last edits made to the file (e.g., file creation date, latest user edits date, etc.). Stated differently, an embodiment may conclude that the change threshold for edits may be exceeded when the date and/or time associated with the current edits to the file is not the same as the date and/or time associated with the last known edits to the file. As a non-limiting example of the foregoing concepts, an embodiment may determine that a change threshold has been exceeded responsive to identifying that an edit to Document A was made after the creation of Document A. Alternatively, in another embodiment, a date/time window may exist in which edits may be made without exceeding the change threshold. For example, the change threshold for edits may be one week from the date of file creation. Any edits made to the file within this week do not exceed the change threshold whereas any edits made outside of this week do exceed the change threshold.

In an embodiment, the change threshold may be based upon a volume of change associated with the edits. More particularly, an embodiment may conclude that a change threshold of edits has been exceeded when an embodiment identifies that a predetermined amount of edits (e.g., predetermined number of insertions, deletions, changes, etc.) have been made to the file. This volume threshold may be originally set by a manufacturer and may be later adjusted by a user. As a non-limiting example of the foregoing concepts, the change threshold of edits may be 5. If less than 5 edits are made to the file then the change threshold is not exceeded whereas if more than 5 edits are made to the file then the change threshold may be considered to be exceeded. Alternatively, in another embodiment, the change threshold may be associated with a volume of change of certain types of edits. For example, a particular file may not have a change threshold for insertion edits but may have a change threshold of deletion edits, which may be set at 5. In this situation, a user may make any number of insertions to the file but may exceed the change threshold when more than 5 deletions are detected.

In an embodiment, the change threshold may be based upon a magnitude of change associated with the edits. More particularly, an embodiment may conclude that a change threshold of edits has been exceeded when one or more edits made to the file changes the file in a substantially significant way. A file may be changed in a substantial way from a plurality of edits or, alternatively, may be deemed significantly changed from a single edit. The parameters that constitute what the magnitude of change is for the file may be originally set by a manufacturer and later adjusted by a user. These parameters may be stored and associated with the file (e.g., as metadata, etc.). As a non-limiting example of the foregoing concepts, in a lease agreement document, if a single change is made to the lessee's name then an embodiment may conclude that a change threshold of edits has been exceeded for the file because the file was changed in a substantially significant way (i.e., a change was made to one of the primary parties to the lease agreement).

In an embodiment, the change threshold may be may be based upon a location of change associated with the edits. More particularly, an embodiment may conclude that a change threshold has been exceeded when edits made to one or more predetermined locations within the file have been detected. The edits made to these locations may be considered to change the file in a substantially significant way. As a non-limiting example of the foregoing concepts, the change threshold may be considered to be exceeded when a change is made to a recipient list in an email file, a header in a word file, and a song title in an audio file.

Responsive to not determining, at 303, that at least one edit exceeds the change threshold, an embodiment may, at 304, save the edits to the original file. Conversely, responsive to determining, at 303, that at least one edit exceeds the change threshold, an embodiment may, at 305, perform an overwrite protection action. In an embodiment, the action may be some action that prevents an immediate overwrite of the original file. In an embodiment, the action may be performed dynamically (i.e., without any additional user input or instruction).

In an embodiment, the action may be a file save prevention action. More particularly, an embodiment may not save those edits to the file that are considered to exceed the change threshold. In another embodiment, the action may be an execution of another type of file save event. For example, instead of saving the edits to the original file, an embodiment may automatically create and/or save the edits considered to exceed the change threshold to a new document, similar to the “save as” function described above.

In an embodiment, the action may be a notification that is provided to the user. The notification may be an audio or visual notification and may be provided to the user via one or more devices known to be associated with the user. In an embodiment, the notification may inform the user that a change threshold of a certain type has been exceeded. Additionally or alternatively, the notification may comprise a user query that requests a user confirmation to save the edits to the file. If user confirmation input is not received in response to the user query, then the edits to the file may not be saved.

The various embodiments described herein thus represent a technical improvement to conventional methods for ensuring that a file is not inadvertently overwritten. Using the techniques described herein, an embodiment may first detect at least one edit made to a file and then receive a file save event that directs the system to save those edits to the file. An embodiment may thereafter determine if those edits exceed a change threshold for the file and, responsive to determining that they do, may automatically perform a certain overwrite protection action (e.g., an embodiment may automatically prevent the edits from being saved to the file, an embodiment may provide the user with a notification and/or query, an embodiment may create a new file containing the edits, etc.). Such a method may ensure that users do not inadvertently save edits to a source file that they are working in.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
detecting, at an information handling device, at least one edit made to a file;
receiving, subsequent to the detecting, a file save event for the file;
determining, using a processor, that at least one edit exceeds a change threshold for the file; and
performing, responsive to the determining, an overwrite protection action.

2. The method of claim 1, wherein the change threshold is based upon a date associated with the file and wherein the determining comprises identifying that the date is not consistent with another date associated with the at least one edit.

3. The method of claim 1, wherein the change threshold is based upon a time associated with the file and wherein the determining comprises identifying that the time is not consistent with another time associated with the at least one edit.

4. The method of claim 1, wherein the change threshold is based upon a volume of change associated with the at least one edit and wherein the determining comprises identifying that the volume of change is greater than a predetermined threshold volume.

5. The method of claim 1, wherein the change threshold is based upon a magnitude of change associated with the at least one edit and wherein the determining comprises identifying that the magnitude of change is greater than a predetermined threshold magnitude.

6. The method of claim 1, wherein the change threshold is based upon a location of change associated with the at least one edit and wherein the determining comprises identifying that the location of change is associated with a magnitude of change to the file that is greater than a predetermined threshold magnitude

7. The method of claim 1, wherein the performing the overwrite protection action comprises providing a query notification to a user.

8. The method of claim 7, wherein the query notification comprises an indication that the at least one edit exceeds the change threshold for the file.

9. The method of claim 1, wherein the performing the overwrite protection action comprises executing another type of file save event.

10. The method of claim 1, wherein the performing the overwrite protection action comprises automatically preventing execution of the file save event.

11. An information handling device, comprising:
a processor;
a memory device that stores instructions executable by the processor to:
detect at least one edit made to a file;
receive, subsequent to the detecting, a file save event for the file;
determine that at least one edit exceeds a change threshold for the file; and
perform, responsive to the determining, an overwrite protection action.

12. The information handling device of claim 11, wherein the change threshold is based upon a date associated with the file and wherein the instructions executable by the processor to determine comprise instructions executable by the processor to identify that the date is not consistent with another date associated with the at least one edit.

13. The information handling device of claim 11, wherein the change threshold is based upon a time associated with the file and wherein the instructions executable by the processor to determine comprise instructions executable by the processor to identify that the time is not consistent with another time associated with the at least one edit.

14. The information handling device of claim 11, wherein the change threshold is based upon a volume of change associated with the at least one edit and wherein the instructions executable by the processor to determine comprise instructions executable by the processor to identify that the volume of change is greater than a predetermined threshold volume.

15. The information handling device of claim 11, wherein the change threshold is based upon a magnitude of change associated with the at least one edit and wherein the instructions executable by the processor to determine comprise instructions executable by the processor to identify that the magnitude of change is greater than a predetermined threshold magnitude.

16. The information handling device of claim 11, wherein the change threshold is based upon a location of change associated with the at least one edit and wherein the instructions executable by the processor to determine comprise instructions executable by the processor to identify that the location of change is associated with a magnitude of change to the file that is greater than a predetermined threshold magnitude

17. The information handling device of claim 11, wherein the instructions executable by the processor to perform the overwrite protection action comprise instructions executable by the processor to provide a query notification to a user.

18. The information handling device of claim 11, wherein the instructions executable by the processor to perform the overwrite protection action comprise instructions executable by the processor to execute another type of file save event.

19. The information handling device of claim 11, wherein the instructions executable by the processor to perform the overwrite protection action comprise instructions executable by the processor to automatically prevent execution of the file save event.

20. A product, comprising:
a storage device that stores code, the code being executable by a processor and comprising:
code that detects at least one edit made to a file;
code that receives, subsequent to the code that detects, a file save event for the file;
code that determines that at least one edit exceeds a change threshold for the file; and
code that performs, responsive to the determining, an overwrite protection action.
